(19) United States
(12) Patent Application Publication
(10) Pub. No.: US 2006/0266048 A1
(43) Pub. Date: Nov. 30, 2006

(54) Fluid catalytic cracking flue gas utility optimizing system and process

(76) Inventors: Leonard E. Bell, Streamwood, IL (US); Keith A. Couch, Arlington Heights, IL (US)

Correspondence Address: HONEY WELL INTELLECTUAL PROPERTY INC;PATENT SERVICES, 101 COLUMBIA DRIVE, P O BOX 2245 MAIL STOP AB/2B, MORRISTOWN, NJ, 07962, US

(21) Appl. No.: 11/139,324

(22) Filed: May 27, 2005

(51) Int. Cl. F02C 7/00

(52) U.S. Cl. 60/783; 60/784

(57) ABSTRACT

A system and method are provided for recovering power from hot flue gas of a catalyst regenerator in an FCC unit. The system includes a temperature reduction device, such as a steam generator, and an expander that can be used, for example, to drive an electrical generator. The temperature reduction device has an uncontrolled temperature inlet and a controlled temperature outlet; and a power recovery expander having an expander inlet and an expander outlet. The expander can be driven by at least some flue gas that is directed from a downstream side of the temperature reduction device to the expander inlet. In an embodiment, a bypass conduit is provided to bypass at least some flue gas from an upstream side of the temperature reduction device to the expander inlet. A process is provided for controlling the generating capacity by varying the bypass flow.

### BACKGROUND OF THE INVENTION

This invention generally pertains to fluid catalytic cracking (FCC) systems, and more particularly to a FCC system having a regenerator from which hot flue gas emissions are directed to a power recovery unit.

FCC technology, now more than 50 years old, has undergone continuous improvement and remains the predominant source of gasoline production in many refineries. This gasoline, as well as lighter products, is formed as the result of cracking heavier (i.e. higher molecular weight), less valuable hydrocarbon feed stocks such as gas oil. Although FCC is a large and complex process involving many factors, a general outline of the technology is presented here in the context of its relation to the present invention.

In its most general form, the FCC process comprises a reactor that is closely coupled with a regenerator, followed by downstream hydrocarbon product separation. Hydrocarbon feed contacts catalyst in the reactor to crack the hydrocarbons down to smaller molecular weight products. During this process, the catalyst tends to accumulate coke thereon, which is burned off in the regenerator.

The heat of combustion in the regenerator typically produces flue gas at temperatures of 677° to 788° C. (1250°to 1450° F.) and at a pressure range of 138 to 276 kPa (20 to 40 psig). Although the pressure is relatively low, the extremely high temperature, high volume of flue gas from the regenerator contains sufficient kinetic energy to warrant economic recovery.

To recover energy from a flue gas stream, flue gas may be fed to a power recovery unit, which for example may include an expander turbine. The kinetic energy of the flue gas is transferred through blades of the expander to a rotor coupled either to a regenerator air blower, to produce combustion air for the regenerator, and/or to a generator to produce electrical power. Because of the pressure drop of 138 to 207 kPa (20 to 30 psi) across the expander turbine, the flue gas typically discharges with a temperature drop of approximately 125° to 167° C. (225 to 300° F.). The flue gas may be run to a steam generator for further energy recovery. Low pressure steam is typically generated at 241-448 kPa (gauge) (35-65 psig). Medium pressure steam is typically generated at 2586-3275 kPa (gauge) (375-475 psig) and high pressure steam is typically generated at greater than 4137 kPa (gauge) (600 psig). The various levels of steam generation can be accommodated through either box-style or shell and tube heat exchangers, but the box-style exchanger must be used if the flue gas is at lower pressure. It is known to provide a power recovery train that includes several devices, such as an expander turbine, a generator, an air blower, a gear reducer, and a let-down steam turbine. The expander turbine may be coupled to a main air blower shaft to power the air blower of a regenerator of the FCC unit.

In order to reduce damage to components downstream of the regenerator, it is also known to remove flue gas solids. This is commonly accomplished with first and second stage separators, such as cyclones, located in the regenerator. Some systems also include a third stage separator (TSS) or even a fourth stage separator (FSS) to remove further fine particles, commonly referred to as ”fines“.

In a conventionally applied power recovery system, the operating temperature of the regenerator dictates the inlet temperature of the flue gas to the power recovery unit. Steam generation conventionally follows power recovery. Because the flue gas temperature is lower after passing through the power recovery unit, the quantity of high pressure steam generation is reduced. To achieve optimal efficiency and cost benefit, improved process configuration and greater control is needed over power recovery components downstream of the regenerator.

### SUMMARY OF THE INVENTION

The present invention provides an FCC flue gas power recovery system having an expander, and a temperature reduction device. Flue gas entering an inlet to the expander can be controlled. In an embodiment, the expander is located downstream of a temperature reduction unit, such as a steam generator, which results in lower temperature flue gas entering the expander. An embodiment further provides a bypass conduit with a modulating valve to permit some of the hot flue gas to communicate from a site upstream of the temperature reduction unit to an inlet of the expander. These features facilitate selected shifting between desired levels of high pressure steam generation and electric power generation, thereby allowing for optimization of power recovery. Advantageously, a refiner using the system can yield additional revenue generation by optimizing steam production and emissions, reducing reliance upon power from external utility companies, improving system control response time to maintain a high pressure steam header pressure, and minimizing low pressure steam production which is typically in excess. While bottom line revenue production will vary from refiner to refiner and application to application, this FCC flue gas utility optimization process can potentially double or triple annual revenue production from that of a conventional power recovery application.

The invention also provides a process for optimizing power recovery. The process includes delivering at least a portion of said gas stream to a temperature reduction device having an inlet and an outlet, wherein a temperature of said gas stream is lower at said outlet; and driving an expander, the expander having an expander inlet, by directing at least some of the gas stream from said outlet of the temperature reduction device into said expander inlet.

In an embodiment, the process further comprises diverting at least some of the gas stream upstream of the temperature reduction device into a bypass conduit, wherein the driving step further includes directing at least some of the gas stream from the bypass conduit into the expander inlet.

The process may further include control features, such as providing a modulating valve operable to restrict flow through the bypass conduit; and varying the driving step by adjusting the modulating valve. The varying step can be controlled as a function of one or more system conditions, such as steam header pressure, power generation, power consumption, temperature or pressure at various locations such as regenerator outlet, TSS inlet, expander inlet, etc.

Advantageously, the system and method can yield optimal efficiency in a refinery, enabling the expander operation to be balanced as increase or decrease in steam generation or electrical generation is needed.

Additional features and advantages of the invention will be apparent from the description of the invention, figures and claims provided herein.

### BRIEF DESCRIPTION OF THE DRAWINGS

FIGS. 1-7 are schematic diagrams of various embodiments of a system for controlling the inlet temperature of a gas stream to a power recovery expander.

### DETAILED DESCRIPTION

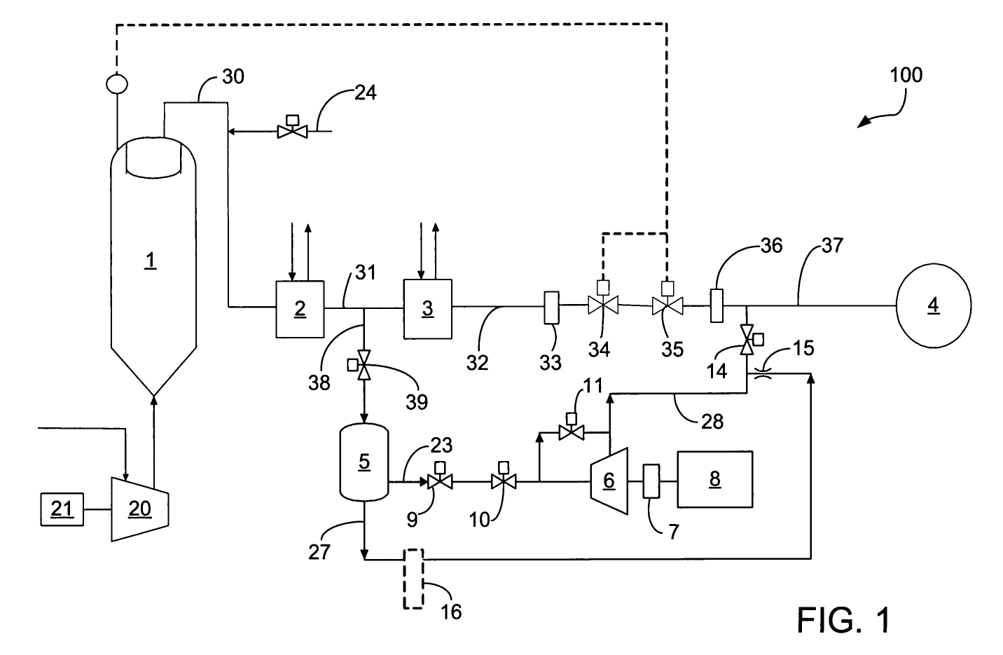

Now turning to the figures, wherein like numerals designate like components, FIG. 1 illustrates an FCC system 100 that is equipped for power recovery. The FCC system 100 generally includes a catalyst regeneration vessel (“regenerator”) 1. A main air blower 20 is driven by a driver 21 to deliver air into the regenerator 1. The driver 21 may be, for example, a motor, a steam turbine driver, or some other device for power input. Hot flue gas exits the regenerator 1 through a conduit 30 which directs the flue gas to a temperature reduction device 2, which is preferably a high pressure steam generator (e.g., a 4137 kPa (gauge) (600 psig) ) (arrows indicate boiler feed water in and high pressure steam out). The temperature reduction device 2 may be a medium pressure steam generator (e.g., a 3102 kPa (gauge) (450 psig)) or a low pressure steam generator (e.g., a 345 kPa (gauge) (50 psig)) in particular situations. As shown in the embodiment of FIG. 1, a boiler feed water (BFW) quench injector 24 is provided to selectively deliver fluid into conduit 30.

A supplemental temperature reduction device 3 may also be provided downstream of the temperature reduction device 2. For example, the supplemental temperature reduction would typically be a low pressure steam generator (arrows indicate boiler feed water in and low pressure steam out), but it may be a high or medium pressure steam generator in particular situations. In the embodiment of FIG. 1, conduit 31 provides fluid communication from temperature reduction device 2 to the supplemental temperature reduction device 3. Flue gas exiting the supplemental temperature reduction device 3 is directed by conduit 32 to a waste conduit 37 and ultimately to an outlet stack 4, which is preferably equipped with appropriate environmental equipment, such as an electrostatic precipitator or a wet gas scrubber. The illustrated example of FIG. 1 further provides that conduit 32 is equipped to direct the flue gas through a first multi-hole orifice (MHO) 33, a first flue gas control valve (FGCV) 34, and potentially a second FGCV 35 and second MHO 36 on the path to waste conduit 37 all to reduce the pressure of the flue gas in conduit 32 before it reaches the stack 4. FGCV's 34, 35 are typically butterfly valves and may be controlled based on a pressure or temperature reading from the regenerator 1.

In order to generate electricity, the system 100 further includes a power recovery expander 6, which is typically a steam turbine, and a power recovery generator (“generator”) 8. More specifically, the expander 6 has an output shaft that typically drives a gear reducer 7 that in turn drives the generator 8. The generator 8 provides electrical power that can be used as desired within the plant or externally.

In a conventionally applied power recovery system, the operating temperature of the regenerator dictates the inlet temperature to the expander. According to an aspect of the present invention, an FCC flue gas power recovery system and method are provided in which an inlet temperature to the expander can be selectively controlled. In accordance with an aspect of the invention, the power recovery expander is located downstream of the temperature reduction device. For example, in the embodiment of FIG. 1, a conduit 38 can divert a portion of the fluid from conduit 31 downstream of the temperature reduction device 2 and upstream of the supplemental temperature reduction device 3. The conduit 38 that feeds the flue gas includes an isolation valve 39 and delivers flow to a third stage separator (TSS) 5, which removes the majority of remaining solid particles from the flue gas. Clean flue gas exits the TSS 5 in line 23 and drives the expander 6. In the system 100, because the expander 6 is driven by flue gas from a downstream side of the temperature reduction device 2, the temperature of the flue gas entering the expander 6 can be varied independently of the operating level of the temperature reduction device 2.

To control flow of flue gas between the TSS 5 and the expander 6, an expander inlet control valve (“on/off control valve”) 9 and throttling valve 10 may be provided upstream of the expander 6 to further control the gas flow entering an expander inlet. The order of valves 9 and 10 may be reversed and these valves are typically butterfly valves. Additionally, a portion of the flue gas stream can be diverted from a location immediately upstream of the expander 6, through a synchronization valve 11, typically a butterfly valve, to join the flue gas in the expander outlet conduit 28. After passing through an isolation valve 14, the clean flue gas in line 28 joins the flowing waste gas downstream of the supplemental temperature reduction device 3 in waste conduit 37 and flows to the outlet stack 4. An optional fourth stage separator 16 can be provided to further remove solids that exit the TSS 5 in an underflow stream in conduit 27. After the underflow stream is further cleaned in the fourth stage separator 16, it can rejoin the flue gas in conduit 28 after passing through a critical flow nozzle 15 that sets the flow rate therethrough.

In order to provide further operational optimization and control over temperature of flue gas entering the expander, an embodiment of the invention provides a bypass conduit to selectively divert flue gas from upstream of the temperature reduction unit directly to the expander inlet. Such a bypass line permits hot flue gas to be directed to the expander without having first flowed through a temperature reduction device, permitting greater flexibility and capacity for generating electrical power. Several embodiments described herein utilize variants of the bypass conduit.

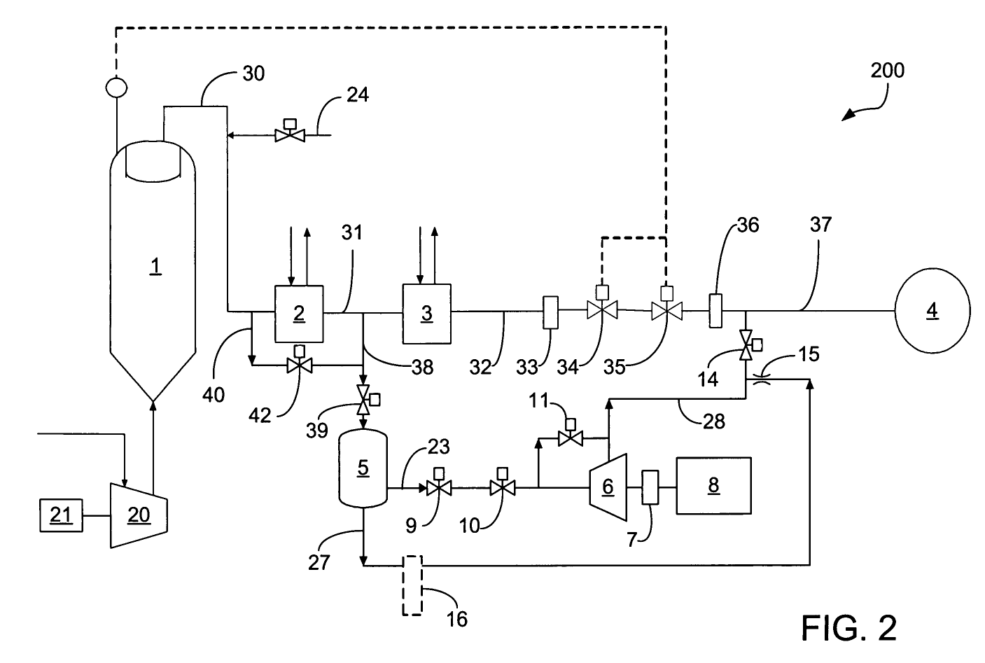

FIG. 2 illustrates a system that utilizes a bypass line. The system 200 of FIG. 2 includes generally the same components as the system 100 of FIG. 1, and further includes bypass conduit 40 and modulating control bypass valve 42 which is typically a butterfly valve. The bypass conduit 40 permits at least a portion of the hot flue gas exiting from the regenerator 1 to bypass the temperature reduction device 2, flowing through the TSS 5 and to the expander 6. As illustrated, the bypass control valve 42 is located in the bypass conduit 40 for selective flow control therethrough. The bypass conduit joins the conduit 38 upstream of the TSS 5.

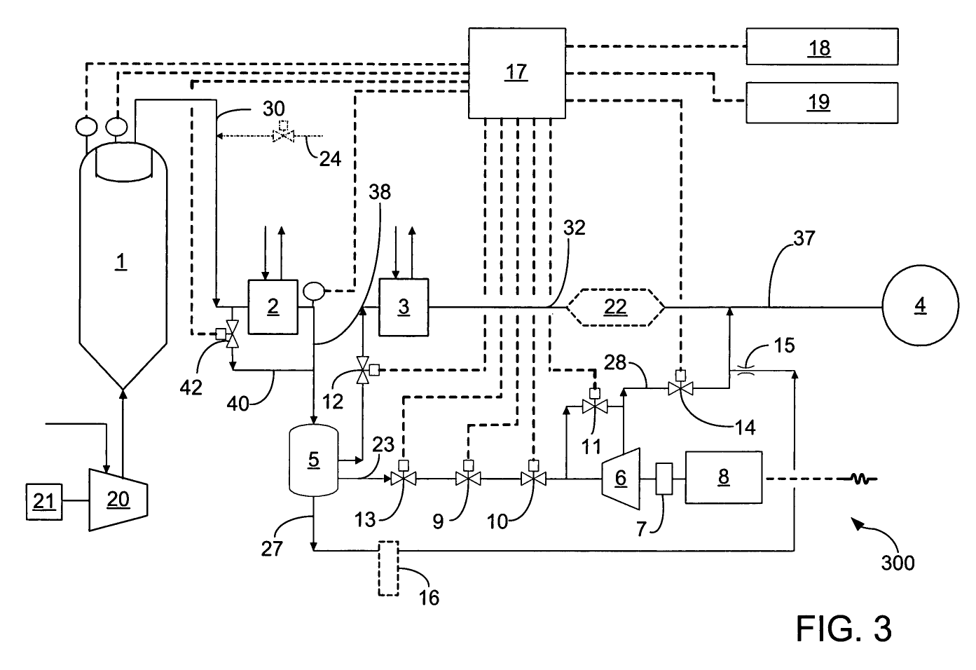

Now turning to FIG. 3, system 300 is illustrated in accordance with another embodiment of the present invention. The system 300 includes the same components as the system 200 described in connection with FIG. 2, except that the TSS 5 is located upstream of the supplemental temperature reduction device 3, and conduit 32 is illustrated without MHO's 33, 36 or FGCV's 34, 35 MHO. Moreover, the BFW injector 24 is optional in FIG. 3 and in other embodiments. Additionally, however, FIG. 3 shows the system 300 to further include an isolation valve 13 upstream of the on/off control valve 9, and a power recovery controller 17. Furthermore, an optional orifice chamber 22 is located in conduit 32 in the passage between the supplemental temperature control device 3 and the waste conduit 37 directed to the stack 4 to reduce the pressure of flue gas in conduit 32. The orifice chamber 22 can replace MHO's 33, 36 or FGCV's 34, 35 of FIGS. 1 and 2 or the latter can be used instead for the pressure reduction function.

The power recovery controller 17 is adapted to receive and continually monitor various conditions reflected by inputs signals transmitted from sensors. It will be understood that any number of sensors may be provided to provide input reflecting respective conditions. For example, in an embodiment, pressure sensor 18 provides a signal indicating the pressure at a high pressure steam header of the refinery, and power sensor 19 provides a signal indicating a power meter level from an electrical substation of the refinery. The controller 17 is programmed to determine various control outputs based upon the conditions reflected by input parameters. As shown in FIG. 3, for example, the controller 17 can send output signals to actuate adjustment of flow restricting devices including valves 9, 10, 11, 12, 13, 14 and of course bypass control valve 42, which can be open, closed, or partially open to a certain degree in an effort to control and/or optimize the flue gas pressure and temperature to the expander inlet and to maximize electrical power generation, while providing dynamic pressure control of the high pressure steam header.

Additional temperature and pressure sensors may feed data to the controller 17. For example, such sensors may be provided to deliver signals indicating temperature and/or pressure at the expander inlet, temperature and/or pressure at the catalyst regeneration vessel 1, temperature and/or pressure at an outlet of the TSS 5, and temperature and/or pressure at an inlet of the supplemental temperature reduction device 3 (e.g., steam generator) or at any part of the system where temperature and/or pressure data may be a desirable measured condition. Sensors may also deliver flow rate condition data to the controller 17.

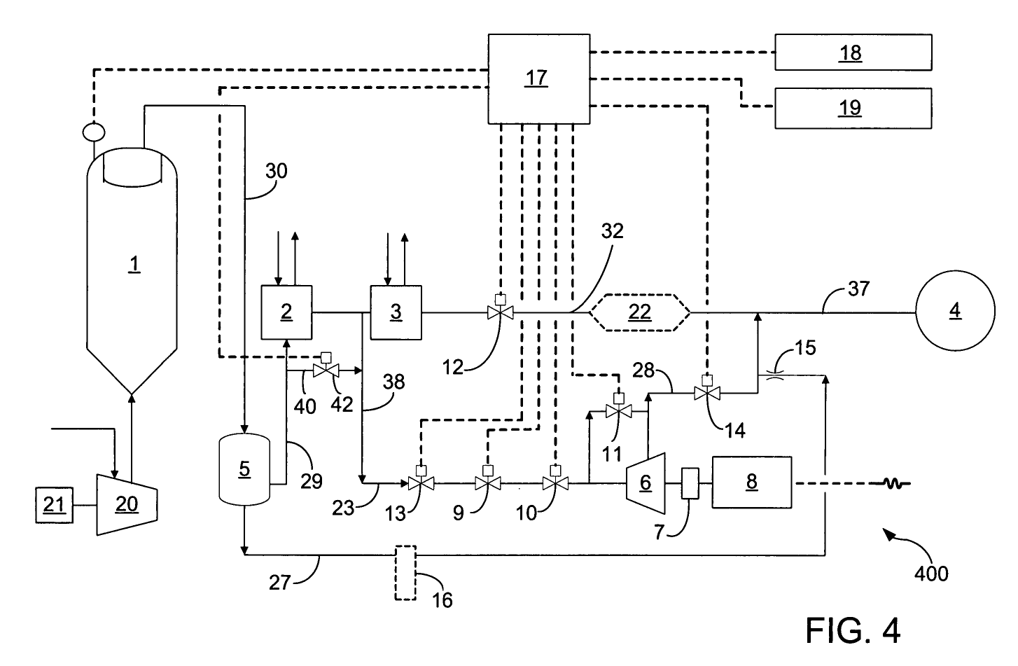

FIG. 4 illustrates a system in accordance with an embodiment of the present invention having a “hybrid” design or configuration. FIG. 4 illustrates a system 400 which is the same as system 300, with the exception that the TSS is positioned upstream of the temperature reduction device 2. In particular, conduit 30 directs all of the flue gas exiting the regenerator 1 through the TSS 5, clean gas exits the TSS 5 through a conduit 29 that can feed directly into the temperature reduction device 2 or can be bypassed through bypass conduit 40 into a conduit 38 that provides communication between a downstream side of the temperature reduction device 2 and the expander 6. In other words, TSS 5 is located upstream of temperature reduction device 2, and expander 6 is downstream of temperature reduction device 2. Bypass conduit 40 can be installed around temperature reduction device 2 to provide the capability to shift, control and/or optimize the energy integration, for example, by reducing high pressure steam production and increasing electrical power generation. As high pressure steam requirements decrease, the bypass valve 42 in bypass conduit 40 can be opened to direct additional clean hot flue gas to the expander 6 to increase production of electrical power. This allows a refiner the capability to shift, control, and/or optimize steam generation and electrical power generation as operating and utility economics shift. The clean reduced or controlled temperature flue gas downstream of temperature reduction device 2 still maintains a high enough pressure and temperature to allow for substantial electrical power generation capability in generator 8.

System 400 includes a power recovery controller 17 as described above in connection with FIG. 3. As in the previously described embodiments, the system 400 facilitates control of flue gas conditions entering the expander, and the bypass conduit 40 permits the inlet flow of the clean flue gas to the expander 6 to be selected in any proportion from upstream and/or downstream of the temperature reduction device 2, enabling the facility to select an optimum balance between the levels of steam power and/or electric power generation at a given time.

The outlet or exhaust temperature in conduit 28 from expander 6 is variable with the expander inlet temperature and the differential pressure across the expander. When high pressure steam generation is maximized at temperature reduction device 2, the exhaust temperature of expander 6 is well below typical FCC flue gas stack design temperatures (i.e., 650° F. typical, 450° F. if a wet gas scrubber is present). As flue gas is diverted around temperature reduction device 2 through bypass conduit 40, the expander outlet temperature increases. The amount of flue gas diverted around temperature reduction device 2 can either be limited to accommodate the design temperature of the existing downstream equipment, or the existing downstream equipment can be modified for a higher design temperature. As will be explained in greater detail, by directing reduced temperature clean flue gas to the expander inlet in conduit 28, significant cost savings may be achieved as a result of reducing the temperatures to which certain system components are subjected.

In the embodiment of FIG. 4, the amount of catalyst passing to bypass valve 42 is minimized. As such, the design differential pressure across bypass valve 42 can be increased without compromising the reliability of the valve. This system design can include an integral orifice plate assembly on expander bypass valve 12 which acts as a system pressure drop device when expander 6 is bypassed. Eliminating the need for an orifice chamber 22 FGCV's 34, 35 and MOHV's 33, 36, the pressure drop requirement can be achieved with an orifice plate assembly integral to the butterfly bypass valve 12. This pressure drop equipment in the embodiments can be interchangeable but the bypass valve 12 with the integral orifice plate is only recommended when located downstream of the TSS 5.

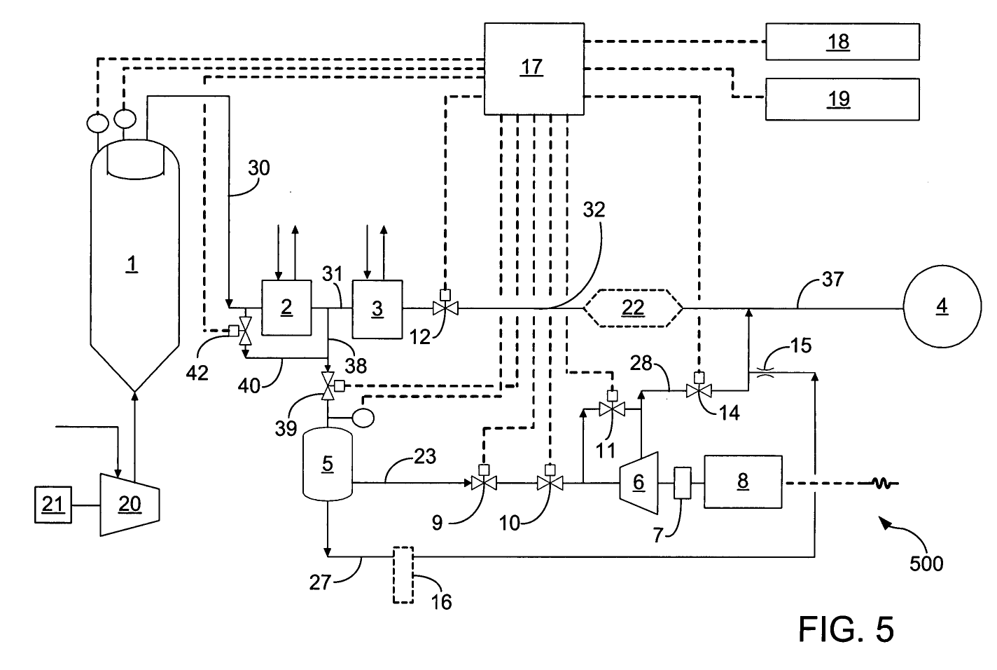

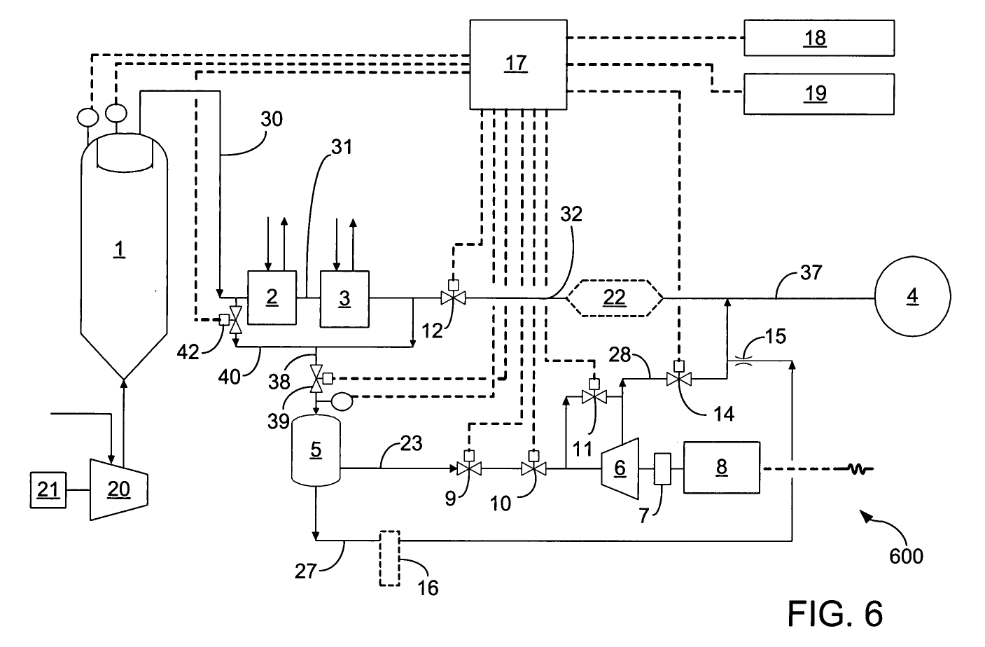

FIGS. 5-6 illustrate systems in accordance with other embodiments of the present invention. In FIG. 5, a system 500 is provided similar to that described in connection with FIG. 2, but with power recovery controller 17. Although not shown, it is also contemplated that the embodiment of FIG. 1 be equipped with a power recovery controller to replace or augment the simpler control system therein.

The present system can also be configured or designed such that bypass conduit 40 is eliminated from TSS 5 and such that expander bypass valve 12 is placed on the flue gas line at a point downstream of the supplemental temperature reduction device 3 (steam generator), as illustrated in FIG. 5. Moreover, the inclusion of the supplemental temperature reduction device 3 is optional in this configuration of the present system. This configuration of FIG. 3 is suitable for use in the present invention, though it may not be the most preferable configuration in some contexts, because the dirty flue gas traveling through temperature reduction devices 2, 3 may increase tube fouling, may result in lower steam production from supplemental temperature reduction device 3, and may leave catalyst in the flue gas leaking through expander bypass valve 12 which may lead to erosion and resultant reliability problems with expander bypass valve 12.

The present system can also be configured or designed such that a primary expander inlet take-off is located downstream of supplemental temperature reduction device 3, as illustrated in FIG. 6. System 600 illustrated in FIG. 6 wherein the TSS 5 is fed only by the bypass conduit 40, which is in fluid communication with sites upstream of the temperature reduction device 2 and downstream of the supplemental temperature reduction device 3. The temperature reduction devices 2 and 3 are shown connected in series, however, it will be appreciated that supplemental temperature reduction device 3 could be eliminated from system 600. Moreover, the configuration of system 600 may be advantageous in a context where temperature reduction device 2 and supplemental temperature reduction device 3 are integral to each other and an expander inlet take-off can not be placed between the two temperature reduction devices. System 600 further includes controller 17 adapted to provide selected control.

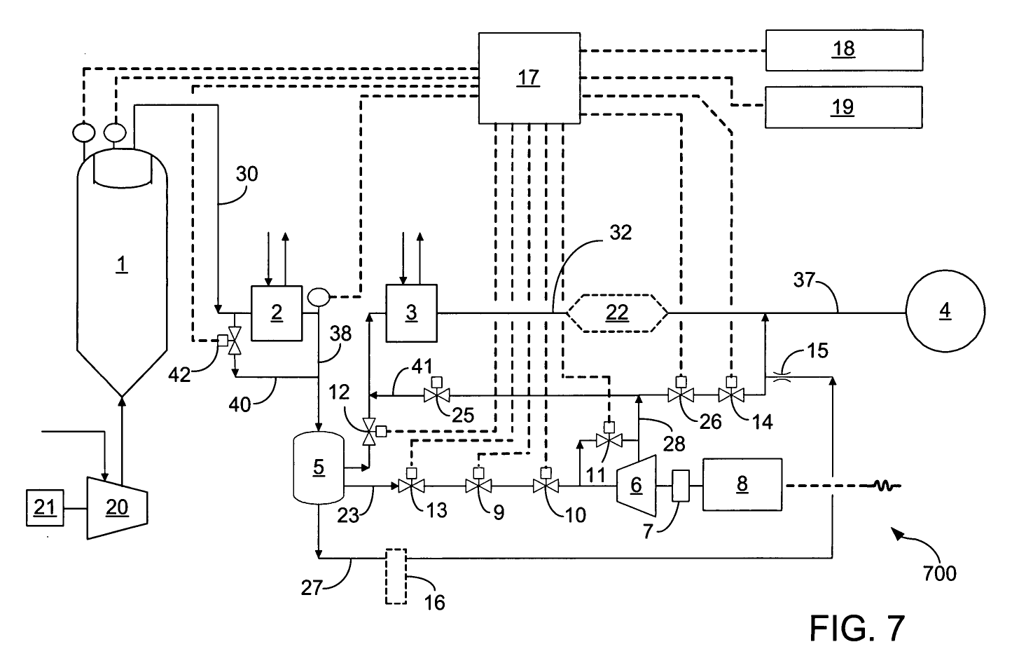

The present system can also be configured to include a recycle of the expander exhaust to the inlet of the supplemental temperature reduction device 3, as illustrated in FIG. 7. System 700 includes the same structure as that described in connection with FIG. 3, with the exception of a conduit 41 and valve 25 enabling the turbine outlet stream in conduit 28 to be directed to an inlet of the supplemental temperature reduction device 3. This configuration facilitates recycling lower temperature expander exhaust back to the inlet of device 3. System 700 includes an over-temperature valve 25 and an expander back-pressure valve 26. In the event of a high regenerator temperature, the controller 17 can restrict expander back-pressure valve 26, e.g., while simultaneously opening up over-temperature valve 25. In an event where a maximum temperature in conduit 37 is exceeded, restricting back-pressure valve 26 will direct more flow to device 3 to cool more flue gas and reduce overall temperature in conduit 37.

Although in the foregoing embodiments the regenerator main air blower 20 is driven by driver 21, the turbine expander 6 may be arranged to drive the main air blower 20 instead of the driver 21 preferably before the expander drives the generator 8. This arrangement would make the driver 21 unnecessary.

### EXAMPLE

The following table shows an exemplary a temperature design envelope for a conventional system versus a system as proposed herein (“Temperature Controlled”):

“Conventional” versus “Temperature Controlled” Power Recovery Process Design

| | Conventional | | Temperature Controlled | |
|---|---|---|---|---|
| | Expander | Expander | Expander | Expander |
| | inlet | outlet | inlet | outlet |
| Pressure, psig | 25-40 | 0.1-5.0 | 25-40 | 0.1-5.0 |
| Temperature, ° F. | 1200-1425 | 900-1200 | 450-1050 | 300-950 |

As can be appreciated from the above table, the reduced flue gas temperature downstream of temperature reduction device 2 allows the entire power recovery system (e.g., vessels, control valves, expansion joints, piping, and duct work, etc.) to be designed and installed with lower cost carbon steel materials as opposed to higher cost stainless steel and cold wall refractory lined materials required by the conventional system in order to withstand the higher temperatures. The reduced temperature system design results in less thermal movement of the flue gas duct, resulting in a reduction in the size, type, and quantity of expansion joints required. This can further reduce the overall installed cost of the reduced temperature system design. Furthermore, since the high pressure steam generation capacity can be maintained in the proposed system by routing the high temperature, pressurized flue gas to the temperature reduction device 2 before the expander 6, a shell and tube heat exchanger can be used for the temperature reduction device 2 to produce steam in addition to or instead of a box-style heat exchanger.

Because the temperature of the flue gas to the proposed power recovery system of the present invention is lower, the power recovery system preferably has a maximum design temperature limit of about 1050° F. or less, which is the maximum temperature design limit for carbon steel based on allowable stress values. The allowable stress values for carbon steel are limited to about 566° C. (1050° F.), in this regard, due to the fact that carbon steel has an excessive oxidation scaling temperature of 566° C. (1050° F.) and a decarburization temperature of 593° C. (1100° F.). Operating temperatures above 566° C. (1050° F.) would require the use of more expensive materials and components.

The proposed power recovery system of the present invention preferably has a minimum design temperature limit that is greater than about 149° C. (300° F.). Operating temperatures less than about 149° C. (300° F.), in this regard, could result in excessive acid gas condensation from the flue gas and potentially severe corrosion to the system. The process can also be operated at about 149° C. (300° F.) or less, though it is considered less preferable because it could require the addition of acid resistant cladding or coating of the flue gas duct, e.g., at a site that is downstream of the flue gas cooler.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A system for recovering power from hot flue gas exiting a regenerator of a fluid catalytic cracking unit, said system comprising:
a temperature reduction device having an inlet that receives hot flue gas and an outlet; and
an expander having an expander inlet and an expander outlet, wherein the expander is driven by at least some flue gas directed from a downstream side of the temperature reduction device into the expander inlet.

2. The system of claim 1, wherein the system further comprises a bypass conduit that provides fluid communication between said expander inlet and a location upstream of said temperature reduction device.

3. The system of claim 2, wherein said temperature reduction device is a medium or high pressure steam generator.

4. The system of claim 2, wherein said expander inlet is in communication with a location downstream of a third stage separator (TSS) which is in communication with a location downstream of a catalyst regeneration vessel.

5. The system of claim 4, wherein the system further comprises a controller that monitors at least one condition and adjusts a modulating control valve on said bypass conduit in response to changes in said monitored condition.

6. The system of claim 5, wherein the system further comprises a generator driven by the expander, and a power sensor that sends a signal to the controller indicating a level of a power meter, wherein said at least one condition includes electrical power output.

7. The system of claim 6, wherein the power meter indicates electrical consumption levels through an electrical substation.

8. The system of claim 5, wherein the system further comprises a high pressure steam header, and a pressure sensor that sends a signal to the controller indicating a pressure at the header, wherein said at least one condition includes the pressure.

9. The system of claim 2, wherein said TSS is in communication with a location upstream of the inlet to the temperature reduction device.

10. The system of claim 1, wherein said expander outlet is in communication with a location upstream of an inlet to a supplemental temperature reduction device.

11. A process for optimizing power recovery from a hot flue gas stream exiting a catalyst regenerator of a fluid catalytic cracking system, the process comprising:
delivering at least a portion of said gas stream to a temperature reduction device having an inlet and an outlet, wherein a temperature of said gas stream is lower at said outlet; and
driving an expander, the expander having an expander inlet, by directing at least some of the gas stream from said outlet of the temperature reduction device into said expander inlet.

12. The process of claim 11, further comprises diverting at least some of the gas stream upstream of the temperature reduction device into a bypass conduit, wherein the driving step further includes directing at least some of the gas stream from the bypass conduit into the expander inlet.

13. The process of claim 12, further comprising:
providing a modulating valve operable to restrict flow through the bypass conduit; and
varying the driving step by adjusting the modulating valve.

14. The process of claim 13, wherein the temperature reduction device is a steam generator, and the process further comprises generating steam.

15. The process of claim 14, further comprising driving a generator with the expander to generate electricity.

16. The process of claim 15, further comprising varying the generating of steam and generating of electricity by adjusting the modulating valve on said bypass conduit.

17. The process of claim 15, further comprising controlling the generating of steam and generating of electricity by adjusting the modulating valve in response to changes in at least one condition.

18. The process of claim 17, whereby the condition is a temperature of the flue gas exiting said catalyst regeneration vessel.

19. The process of claim 17, whereby the condition is a temperature of the flue gas at the expander inlet.

20. A system for recovering power from hot flue gas departing a regenerator of a fluid catalytic cracking unit, said system comprising:
a temperature reduction device having an inlet and a controlled temperature outlet; and
a power recovery expander having an expander inlet and an expander outlet, said expander inlet being in downstream communication with said controlled temperature outlet

21. The system of claim 20, wherein the system farther comprises a bypass conduit that provides fluid communication between said expander inlet and a location upstream of said inlet to said temperature reduction device.
